(19) United States
(12) Patent Application Publication
(10) Pub. No.: US 2025/0354852 A1
(43) Pub. Date: Nov. 20, 2025

(54) Sensor With Fiber Optic Liquid Level Switch, Assembly, and Methods of Making and Using the Same

(71) Applicant: Westermeyer Industries Inc., Bluffs, IL (US)

(72) Inventors: Gary W. Westermeyer, Bluffs, IL (US); David Robert Frenk, Chatham, IL (US)

(73) Assignee: Westermeyer Industries Inc., Bluffs, IL (US)

(21) Appl. No.: 19/178,945

(22) Filed: Apr. 15, 2025

Related U.S. Application Data
(60) Provisional application No. 63/634,618, filed on Apr. 16, 2024.

(51) Int. Cl. G01F 23/292

(52) U.S. Cl. CPC G01F 23/2927

(57) ABSTRACT

An assembly is disclosed herein that is configured to detect a liquid level in a liquid-containing vessel, the assembly comprising a first electrical circuit board disposed in a case and including an LED emitting component, an LED detecting component, and a switch-activating component, a sight window assembly configured to be mounted in an opening in a wall of the liquid-containing vessel at a location remote from the case, the sight window assembly including a housing with a first end section supporting a glass component with an apex configured to be disposed proximate the inner side of the wall of the vessel, and a second end section supporting a cable support module, a first fiber optic cable connecting the LED emitting component to the glass component and a second fiber optic cable connecting the LED detecting component to the glass component, the second fiber optic cable transmitting light reflected through the glass component to the LED detecting component when gas is present in the vessel at a designated level adjacent to the glass component, and not transmitting light when liquid is present in the vessel at the designated level adjacent to the glass component. An electrical switch is configured to be in a first position when reflected light is detected by the LED detecting component, and in a second position when reflected light is not detected by the LED detecting component.

### RELATED APPLICATIONS

This application claims the benefit of U.S. Provisional Patent Application No. 63/634,618 filed Apr. 16, 2024, the contents of which are incorporated by reference herein in their entirety.

### BACKGROUND

Liquid-containing pressurized vessels are used in a variety of industrial and commercial systems. Conventional vessels may have one or more sight glass ports along their length through which the liquid level in the vessel can be monitored. When liquid levels rise above or fall below the desired level, the system is adjusted by adding or removing liquid.

It would be useful to automate the viewing of liquid levels in liquid-containing vessels in order to rapidly respond to small system changes.

### SUMMARY

One embodiment described herein is an assembly configured to detect a liquid level in a liquid-containing open or closed system vessel. The assembly comprises a case, a first electrical circuit board disposed in the case, which includes an LED emitting component, an LED detecting component, and a switch-activating component, and a sight window assembly configured to be mounted in an opening in a wall of the liquid-containing vessel at a location remote from the case, the wall having an inner side and an outer side. The sight window assembly includes a housing with a first end section supporting a glass component with an apex configured to be disposed proximate the inner side of the wall of the vessel, and a second end section containing a cable support module. The assembly also includes a first fiber optic cable with a first end portion including a first terminal end connected to the LED emitting component and a second end portion connected to the cable support module with a second terminal end disposed adjacent to the glass component of the sight window assembly. The first fiber optic cable transmits light from the LED emitting component into the vessel through the glass component. The assembly also includes a second fiber optic cable with a first end portion including a first terminal end connected to the LED detecting component and a second end portion connected to the cable support module with a second terminal end disposed adjacent to the glass component of the sight window assembly. The second fiber optic cable transmits light reflected through the glass component to the LED detecting component when gas is present in the vessel at a designated level adjacent to the glass component, and does not transmit light when liquid is present in the vessel at the designated level adjacent to the glass component. The assembly further includes an electrical switch configured to be in a first position when reflected light is detected by the LED detecting component, and in a second position when reflected light is not detected by the LED detecting component, the electrical switch activating at least one of: a valve adjusting the liquid level in the vessel, an alarm system indicating the liquid level in the vessel is in need of adjustment, and a power interruption module configured to suspend operation of a mechanical pump or compressor influencing liquid height in the vessel.

Another embodiment is an assembly configured to detect a liquid level in a liquid-containing vessel, the assembly comprising a sight window assembly configured to be mounted in an opening in a wall of the liquid-containing vessel, the wall having an inner side and an outer side, the sight window assembly including a housing with a first end section supporting a glass component with an apex configured to be disposed proximate the inner side of the wall of the vessel, and a second end section containing an extended support component including a passage support portion, a case portion, and a central extension portion connecting the passage support portion to the case portion. A first electrical circuit board is disposed in the case portion. The first electrical circuit board includes an LED emitting component, an LED detecting component, and a switch-activating component. The assembly also includes a first passage with a first end portion including a first terminal end adjacent to the LED emitting component and a second end portion connected to the passage support portion of the extended support component with a second terminal end disposed adjacent to the glass component of the sight window assembly, the first passage directing light from the LED emitting component into the vessel through the glass component, and a second passage with a first end portion including a first terminal end adjacent to the LED detecting component and a second end portion connected to the second passage support portion with a second terminal end disposed adjacent to the glass component of the sight window assembly, the second passage directing light reflected through the glass component to the LED detecting component when gas is present in the vessel at a designated level adjacent to the glass component, and not directing light when liquid is present in the vessel at the designated level adjacent to the glass component. The assembly further includes an electrical switch configured to be in a first position when reflected light is detected by the LED detecting component, and in a second position when reflected light is not detected by the LED detecting component, the electrical switch activating at least one of a valve adjusting the liquid level in the vessel, an alarm system indicating the liquid level in the vessel is in need of adjustment, and a power interruption module configured to suspend or alter operation of a mechanical pump or compressor influencing liquid height in the vessel.

### BRIEF DESCRIPTION OF THE DRAWINGS

FIG. 1 shows an overall view of a first embodiment of the liquid sensing assembly.

FIG. 2 depicts a cross-sectional view of the optical housing, including the connection to the fiber optic cables.

FIG. 3 is a bottom view of the case containing the electrical circuit board, with the bottom portion of the enclosure removed.

FIG. 4A depicts a non-limiting version of a closed switch for the liquid level control monitored in the embodiments described herein.

FIG. 4B depicts the switch of FIG. 4A when in an open position.

FIG. 5 shows a non-limiting example of a vessel having three liquid sensing assemblies mounted thereon.

FIG. 6 schematically shows a compressor system that incorporates the liquid sensing assembly shown in FIG. 1.

FIG. 7 schematically shows a second embodiment of a liquid sensing assembly.

### DETAILED DESCRIPTION

A fiber optic liquid level switch assembly is described herein which can be used to detect levels of fluids, such as a refrigerant or oil, in a system that is subjected to high temperatures and/or pressures, as well as other harsh environmental conditions.

Commercial and industrial refrigeration systems often have large cooling loads to maintain, sometimes within very narrow temperature limits. The thermal loads can be costly if the temperature deviates above or below the set limits for as little as one hour. To ensure uninterrupted operation, these large and complex refrigeration systems rely on many detection devices to activate alarms, and to open and close other refrigerant or oil piping networks. Detection devices can be complex in nature, collecting several operating parameters and storing the data on a local computing device or a remote cloud server.

The system described herein incorporates monitoring devices that open and close electrical relays that control flow of fluids within the system, and in some cases are configured to slow or interrupt operation of major components. In one embodiment, such devices are used for opening and closing a solenoid valve in a compressor oil management system to ensure the compressor has a continuous supply of oil. This device acts as a switch, operating between open and closed states. For the switch to determine a state based on the oil or refrigerant level, the device monitors the liquid levels using light reflection and/or refraction. More specifically, optics are used to determine if liquid is present at a specific height in a vessel. The device's optics are at a fixed height on the vessel, and the switch can be activated as the level passes above or below this position.

In embodiments, the light reflection and refraction system employs a prism, which can be a conical prism. The cone is made of glass. The cone is exposed to the medium (liquid or gas) to be detected. An LED emitter and detector work in tandem. The shape of the cone comprising the optics allows a light source to reflect internally with no liquid detected, and to refract when liquid is detected. Thus, when the liquid medium being detected is not present at the cone surface, the light is internally reflected to the receiver. On the other hand, if the liquid is present and covering the surface of the cone, the LED light source is refracted and not returned to the receiver.

U.S. Pat. No. 5,278,426 describes a liquid level sensor for use in systems which includes a window mounted on a vessel. The window has a prismatic interior face, a flat exterior face, and an electronic module adjacent the flat exterior face. The electronic module provides a light source and generates electronic signals indicating the presence or absence of light at the detector, thereby indicating the presence or absence of liquid at the level of the window. The embodiments described herein utilize similar light reflection techniques to those described in U.S. Pat. No. 5,278,426. However, due to circuit space limitations, the device described in U.S. Pat. No. 5,278,426 is bound by operating temperature limitations as set by the internal electrical components and is not constructed in a manner suitable to incorporate additional functionality, including audio alerts, wireless data connections, and/or additional information processing systems. The system described herein can be used in conjunction with systems having high temperatures and operating pressures.

As used herein, the term “glass component” means a clear component having the shape of a cone or prism and being made from a material that enables light to be refracted and reflected, thereby distinguishing the presence of liquid versus gas adjacent to the glass component. The term “glass support module” refers to a structure configured to support the glass component in an opening in the side of a vessel.

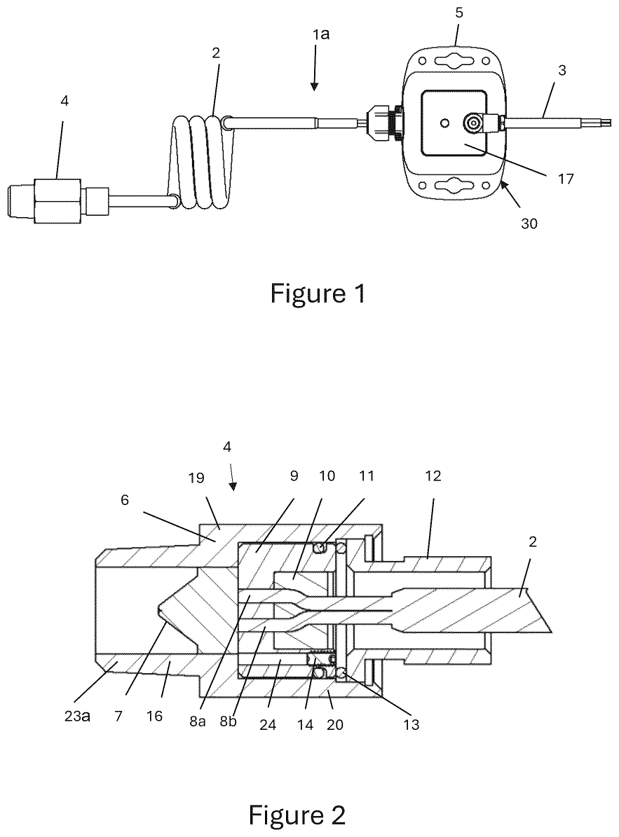

Referring to the drawings, FIGS. 1-5 show a liquid sensing assembly, generally designated as 1a. The assembly 1a includes a fiber optic conduit 2 extending from an electronics module 30, including a rigid or semi-rigid case 5 which houses a circuit board 17, to a sight glass housing assembly 4. The sight glass housing assembly 4 is configured to be mounted adjacent a window opening 42a of a vessel 41 containing a liquid to be sensed. The circuit board 17 is connected by an electrical cord 3 to a power source.

FIG. 2 details the internal structure of the sight glass housing assembly 4. The assembly 4 includes a housing 6, which supports a light transmitting glass component, such as a cone 7, and a connection for the fiber optic conduit 2. The housing 6 functions as a glass support module and has a first end portion 16 with an externally threaded section 23a configured to be installed in a mating connection of a liquid container, a central portion 19 that supports the cone 7, and a second end portion 20 that contains a cable support module 9 that supports the connection of the fiber optic conduit 2 to the cone 7. More specifically, the fiber optic conduit 2 contains the first end portions of two individual fiber cables 8a, 8b connected to the cable support module 9 and secured by an adhesive, such as an epoxy, or the like, in a cavity 10 within the module 9. The module 9 is disposed adjacent to the cone 7. The module 9 is held in place within housing 6 by a retainer 12. The module 9 holds the ends of the fiber optic cables 8a, 8b in place. The module comprises a material that is not susceptible to corrosion or electrochemical oxidation, and thus is non-ferrous. In embodiments, the module 9 is machined and comprises a metal such as stainless steel or brass.

A first resilient O-ring 11 is disposed around the inner perimeter of the module 9 and prevents vapor from entering the small volume between housing 6 and module 9. Upon installing module 9 within housing 6, residual air must be evacuated through port 24 and then sealed with a threaded insert 14 or the like. A second (compression) resilient O-ring 13 is installed between the module 9 and the retainer 12.

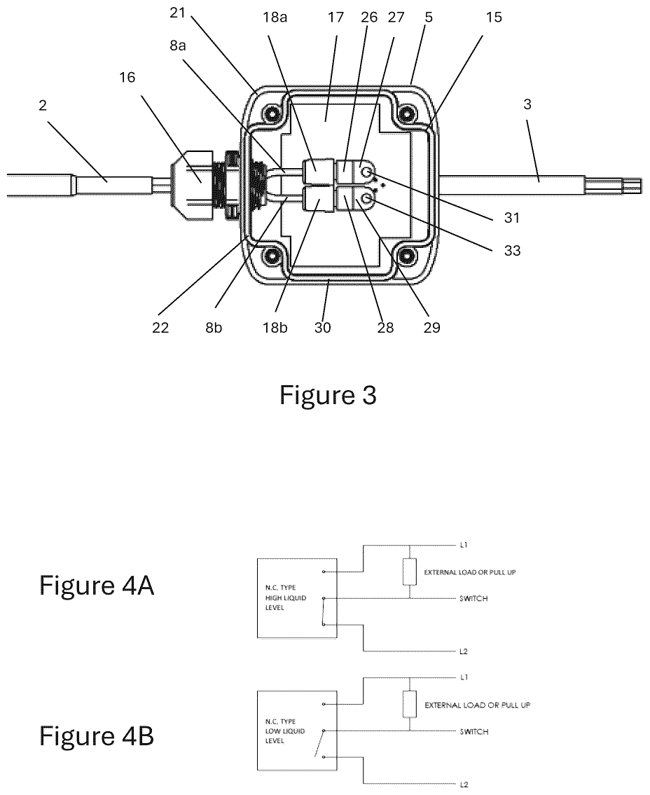

FIG. 3 shows the details of the opposing end of the fiber optic conduit 2 and the associated electronics. The fiber optic cables 8a and 8b are supported at the outer side of case 5 by a cable holder 16. The cables 8a and 8b extend through the wall 21 of the case 5 and through a wall 22 of an electronics housing 15 that supports an electrical circuit board 17 with connectors 18a, 18b for the fiber optic cables 8a, 8b, respectively. The connector 18a is configured for sending light generated by an LED emitter 26 through the cone 7, and the connector 18b is configured for receiving the reflected light into a light detector 28 in the case that reflection occurs due to the absence of liquid at the cone 7. Support 27 and support 29 allow for mounting the light emitter 26 and light detector 28, respectively, in place on the circuit board 17. The electrical connections are adjacent to through-holes 31, 33. The circuit board 17 can be powered by a hard wire 3.

FIGS. 4A and 4B show the details of the switch system incorporated into the circuit board 17 for controlling external devices. The on-off settings of the switch depend on the type of vessel with which the assembly is used. In some embodiments, when liquid is present adjacent to cone 7, the detector 28 does not detect reflected light and the switch is closed as is shown in FIG. 4A, and when liquid is not present at cone 7, the detector 28 detects reflected light and the switch is open as is shown in FIG. 4B. In other embodiments the switch is configured in order that when liquid is present adjacent to cone 7, the detector does not detect reflected light and the switch is open, and when liquid is not present adjacent to cone 7, the detector does not detect reflected light and the switch is closed.

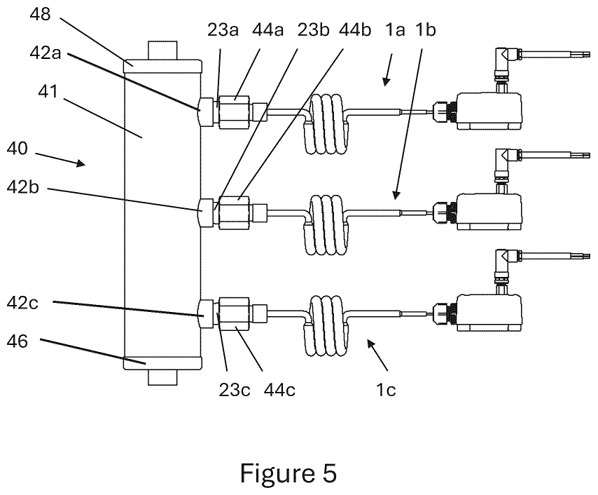

FIG. 5 schematically shows an assembly 40 with three liquid sensing assemblies 1a, 1b, 1c connected to a vessel 41 with multiple internally threaded ports 42a, 42b, 42c accepting external threads 23a, 23b, 23c, respectively, of upper sight glass housing assembly 44a, intermediate sight glass housing assembly 44b and lower sight glass housing assembly 44c. Three separate assemblies are included in order to detect liquid levels at various heights within the vessel 41. The vessel 41 may be, for example, an oil reservoir, a vessel containing a refrigerant, or another type of vessel containing a liquid. In some embodiments, the vessel has an operating pressure in the range of 0-1000 psig.

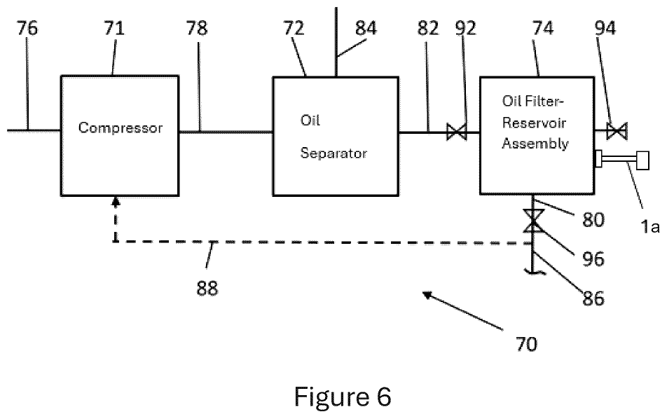

The embodiment shown in FIG. 5 includes a vessel 41, which typically is tubular and has length of about 25 to 60 inches and an outer diameter of about 4 to about 20 inches, or about 6 to about 14 inches. A bottom cap 46 is attached to the lower end portion of the vessel 41, and an upper cap 48 is removably or permanently attached to the upper end portion of the vessel 41. In the embodiment shown in FIG. 5, an upper sight glass is included and contained within the upper sight glass housing assembly 44a, an intermediate sight glass is included along the middle section of the shell, and is contained within the intermediate sight glass housing assembly 44b, and a lower sight glass is provided on the lower end portion of the shell 41, and is contained within the lower sight glass housing assembly 44c. In embodiments, a lower spud is welded to the bottom cap to provide a liquid-tight connection between the oil outlet from the assembly and an oil outlet line. The oil from the oil outlet line can be returned to the compressor directly, disposed, or further treated and then returned to the compressor. In some cases, the electronics module 30 includes, or is electronically connected to, one or more peripheral devices, including but not limited a supplemental time delay circuit, a wireless communication circuit, and a selectable voltage switch. FIG. 6 schematically shows a system 70 that includes a compressor 71, an oil separator 72 and an oil filter-reservoir assembly 74. Gaseous refrigerant enters the compressor 71 in refrigerant line 76. A compressor outlet line 78 contains compressed gaseous refrigerant with small quantities of gaseous oil from the compressor 71. The gaseous mixture in line 78 enters the oil separator 72 in which separated oil is removed as a liquid and returned in oil outlet line 82 and gaseous refrigerant is removed in a refrigerant outlet line 84. The refrigerant is fed to a condenser (not shown) from which liquid refrigerant is removed. The separated oil in line 82 is fed to an oil filter-reservoir assembly 74. The filtered oil removed from assembly 74 in line 80 can be transported in line 86 for further processing or can be returned to the compressor in line 88.

When the filter in the oil filter-reservoir assembly 74 needs servicing, valve 92, which is upstream from the oil filter-reservoir assembly 74 in line 82, and filtered oil outlet valve 96, which is downstream from the oil filter-reservoir assembly 74 in line 80, are closed. Vent valve 94 is also closed when servicing. Once the vent valve 94 is used to relieve the internal pressure of assembly 74, the header plate of the oil filter-reservoir assembly 74 can then be removed and the filter can be replaced, repositioned and/or cleaned. The assembly of FIG. 1 can control either or both of valves 92 and 96. Valve 92 can be actuated (opened) if the oil level within oil separator 72 is at an appropriate level as detected by the assembly in FIG. 1. Similarly valve 96 can be actuated appropriately for directing oil to the compressor 71 in response to the switch condition of the assembly in FIG. 1.

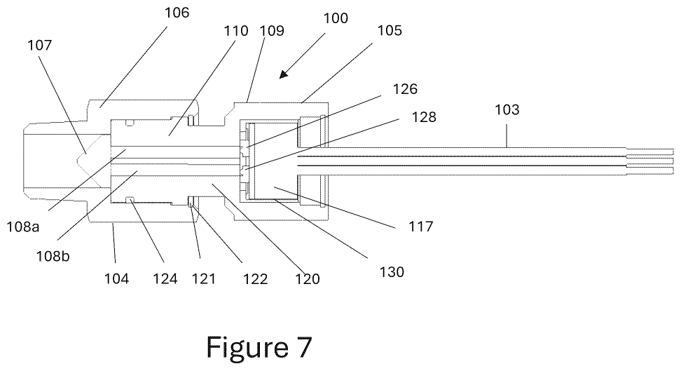

FIG. 7 shows an alternative embodiment involving a switch extension. The assembly is designated as 100. This embodiment provides support for an electronics module 130 containing a circuit board 117 in an extended support component 109 comprising a first portion 110 disposed inside a housing 106 which contains a glass component 107 and functions as part of the sight glass housing assembly 104, a case portion 105 disposed outside the housing 106, and a central extension portion 120 connecting the first portion 110 to the case portion 105. In embodiments, the extended support component 109 comprises a thermoplastic material such as nylon, or a thermoset material, in order to minimize heat transfer from the housing 106 to the electronics module 130 and its components. In the embodiment shown in FIGS. 7-8, the extended support component 109 is retained in the housing 106 by a C-clip 121 in a groove 122. The LED emitter 126 directs the light down passage 108a, reflects from the glass component 107 if no liquid present, and the reflected light is transmitted through passage 108b to the detector 128. In embodiments, the housing 106 is made from steel. A soft elastomeric seal 124 is included to prevent access of humid air where this may condense and/or freeze on the non-pressure side of glass component 107 adjacent to first portion 110 of the extended support component 109. In embodiments the passages 108a and 108b are tubular. In embodiments, the passages 108a and 108b are straight (linear). The switch extension serves the same overall purpose as the embodiment of FIGS. 1-5 by removing the electronics from the body 103 but does not provide for expanding the circuit for increased functionality due to space constraints of the circuit board 117. The extended support component 109 limits heat transfer from the housing 106 to allow the electronics in module 130 to operate within design limits when the vessel is operated. In embodiments, this configuration is particularly useful for vessels operating a pressure in the range of about 100 to about 1000 psig and a temperature in the range of about −55 Deg. F to about 300 Deg. F. Testing has demonstrated the housing 106 can nearly approach the temperature of 300 Deg. F (the temperature of the operating fluid in the vessel which the module 130 is responsible for detecting), while keeping the electronics module 130 at an operable temperature, e.g. a temperature at or below about 200 Deg. F. In embodiments, the circuit board 117 is spaced about 3.0 cm to 3.6 cm away from the housing 106.

In embodiments, the system is designed with a maximum working pressure in the range of about 300 psig to about 1200 psig, or about 400 psig to about 1000 psig. In some embodiments, the system is designed with a maximum working pressure of 350 psig to 500 psig, or 400 psig to 480 psig. In certain cases, the system is designed with a maximum working pressure of about 500 to 800 psig, or about 600 to 700 psig. The components are constructed with thicker walls when higher pressures are used. In embodiments, the vessel operates at about atmospheric pressure (0 psig). In some cases, the vessel operates at a pressure in the range of 0.5 psia to 14.7 psia (1 atm). below atmospheric pressure.

In embodiments, the system is designed to operate at an internal vessel temperature in the range of about −50 Deg. F to about 400 Deg. F, or about −40 Deg. F to about 300 Def. F. High temperature systems typically operate in the range of about 100 Deg. F. to about 300 Deg. F. Low temperature systems typically operate in the range of about −40 Deg. F to about 40 Deg. F.

In some cases, the vessel is tubular and has length or height of about 2 feet to about 12 feet, or about 2 feet to about 6 feet, and an outer diameter of about ⅓ foot to about 8 feet, or about ⅓ foot to about 3 feet. In some cases, the vessel has a capacity of about 1 to about 100 gallons of liquid, or about 5 to about 50 gallons of liquid, or about 5 to about 30 gallons of liquid.

In some cases, the vessel is an oil reservoir. In embodiments, the oil reservoir has a capacity of about 1 to about 15 gallons of oil, or about 2 to about 10 gallons of oil, or about 2 to about 5 gallons of oil.

In some cases, the vessel contains a refrigerant. In embodiments, the vessel has a capacity of about 5 lbs to about 500 lbs, or about 20 lbs to about 300 lbs, or about 50 lbs to about 100 lbs of refrigerant.

In embodiments, each of the first fiber optic cable and the second fiber optic cable has a length in the range of about 10 cm to about 300 cm, or about 10 cm to about 60 cm.

The assemblies described herein can be used to monitor and/or control liquid flows in a vessel. In some cases, the assembly can be used in methods of automatically controlling liquid levels in a liquid-containing vessel, comprising positioning the assembly in a side wall of a vessel and controlling liquid flow using the assembly. In other cases, a method of automatically detecting changes in liquid levels in a liquid-containing vessel comprises positioning the assembly in a side wall of the vessel and detecting liquid levels using the assembly. In other embodiments, a method of automatically detecting changes in liquid levels in a liquid-containing vessel and automatically changing the liquid levels, comprises positioning the assembly in a side wall of the vessel, and detecting and controlling liquid flow using the assembly.

A number of alternatives, modifications, variations, or improvements therein may be subsequently made by those skilled in the art, which are also intended to be encompassed by the following claims.

What is claimed is:

1. An assembly configured to detect a liquid level in a liquid-containing vessel, the assembly comprising:
a case,
a first electrical circuit board disposed in the case, the first electrical circuit board including an LED emitting component, an LED detecting component, and a switch-activating component,
a sight window assembly configured to be mounted in an opening in a wall of the liquid-containing vessel at a location remote from the case, the wall having an inner side and an outer side, the sight window assembly including a housing with a first end section supporting a glass component with an apex configured to be disposed proximate the inner side of the wall of the vessel, and a second end section containing a cable support module,
a first fiber optic cable with a first end portion including a first terminal end connected to the LED emitting component and a second end portion connected to the cable support module with a second terminal end disposed adjacent to the glass component of the sight window assembly, the first fiber optic cable transmitting light from the LED emitting component into the vessel through the glass component,
a second fiber optic cable with a first end portion including a first terminal end connected to the LED detecting component and a second end portion connected to the cable support module with a second terminal end disposed adjacent to the glass component of the sight window assembly, the second fiber optic cable transmitting light reflected through the glass component to the LED detecting component when gas is present in the vessel at a designated level adjacent to the glass component, and not transmitting light when liquid is present in the vessel at the designated level adjacent to the glass component, and
an electrical switch configured to be in a first position when reflected light is detected by the LED detecting component, and in a second position when reflected light is not detected by the LED detecting component, the electrical switch activating at least one of:
a valve adjusting the liquid level in the vessel,
an alarm system indicating the liquid level in the vessel is in need of adjustment, and
a power interruption module configured to suspend operation of a mechanical pump or compressor influencing liquid height in the vessel.

2. The assembly of claim 1, wherein the vessel is configured to be operated at a pressure above atmospheric pressure.

3. The assembly of claim 1, wherein the vessel is configured to be operated at a pressure no higher than atmospheric pressure.

4. The assembly of claim 1, wherein the first position of the electrical switch is an open position and the second position of the electrical switch is a closed position.

5. The assembly of claim 1, wherein the electrical switch activates a valve.

6. The assembly of claim 1, wherein the first electrical circuit board includes an alarm.

7. The assembly of claim 1, wherein the first electrical circuit board includes a data transmitter configured to transmit to a remote computer data indicative of the liquid level in the vessel.

8. The assembly of claim 1, wherein the first electrical circuit board includes a data transmitter for remote data storage.

9. The assembly of claim 1, wherein the cable support module comprises a cylindrical support comprising a material not susceptible to corrosion or electrochemical oxidation.

10. The assembly of claim 1, wherein the glass component has a central axis, and the cable support module includes:
a first opening configured to support the second terminal end of the first fiber optic cable at a first location offset from the central axis, and
a second opening configured to support the second terminal end of the second fiber optic cable at a second location offset from the central axis.

11. The assembly of claim 10, wherein the cable support module comprises a cylindrical support and the first and second openings comprise first and second bores formed in the cylindrical component.

12. The assembly of claim 10, wherein the second end portion of the first fiber optic cable and the second end portion of the second fiber optic cable are held in a stationary position in the sight window assembly by an adhesive.

13. The assembly of claim 1, further including at least one of the following peripherals: a supplemental time delay circuit, a wireless communication circuit, and a selectable voltage switch.

14. The assembly of claim 1, wherein the vessel comprises an oil reservoir.

15. The assembly of claim 1, wherein the vessel contains a refrigerant.

16. An assembly configured to detect a liquid level in a liquid-containing vessel, the assembly comprising:
a sight window assembly configured to be mounted in an opening in a wall of the liquid-containing vessel, the wall having an inner side and an outer side, the sight window assembly including a housing with a first end section supporting a glass component with an apex configured to be disposed proximate the inner side of the wall of the vessel, and a second end section containing an extended support component including a passage support portion, a case portion, and a central extension portion connecting the passage support portion to the case portion,
a first electrical circuit board disposed in the case portion, the first electrical circuit board including an LED emitting component, an LED detecting component, and a switch-activating component,
a first passage with a first end portion including a first terminal end adjacent to the LED emitting component and a second end portion connected to the passage support portion of the extended support component with a second terminal end disposed adjacent to the glass component of the sight window assembly, the first passage directing light from the LED emitting component into the vessel through the glass component,
a second passage with a first end portion including a first terminal end adjacent to the LED detecting component and a second end portion connected to the passage support portion of the extended support component with a second terminal end disposed adjacent to the glass component of the sight window assembly, the second passage directing light reflected through the glass component to the LED detecting component when gas is present in the vessel at a designated level adjacent to the glass component, and not directing light when liquid is present in the vessel at the designated level adjacent to the glass component, and
an electrical switch configured to be in a first position when reflected light is detected by the LED detecting component, and in a second position when reflected light is not detected by the LED detecting component, the electrical switch activating at least one of:
a valve adjusting the liquid level in the vessel,
an alarm system indicating the liquid level in the vessel is in need of
adjustment, and
a power interruption module configured to suspend operation of a mechanical pump or compressor influencing liquid height in the vessel.

17. The assembly of claim 16, wherein the first position of the electrical switch is an open position and the second position of the electrical switch is a closed position.

18. A method of automatically controlling liquid levels in a liquid-containing vessel, comprising positioning the assembly of claim 1 in a side wall of the vessel and controlling liquid flow using the assembly.

19. A method of automatically detecting changes in liquid levels in a liquid-containing vessel, comprising positioning the assembly of claim 1 in a side wall of the vessel and detecting liquid levels using the assembly.

20. A method of automatically detecting changes in liquid levels in a liquid-containing vessel and automatically changing the liquid levels, comprising positioning the assembly of claim 1 in a side wall of the vessel, and detecting and controlling liquid flow using the assembly.
